(19) United States
(12) Patent Application Publication
(10) Pub. No.: US 2023/0378602 A1
(43) Pub. Date: Nov. 23, 2023

(54) METHOD FOR MANUFACTURING BINDER FOR COATING SECONDARY BATTERY SEPARATOR

(71) Applicants: Electronics and Telecommunications Research Institute, Daejeon (KR); APEC, LTD., Ansan-si (KR)

(72) Inventors: Jaecheol CHOI, Daejeon (KR); Sang Won HWANG, Ansan-si (KR); Jun Hee PARK, Ansan-si (KR); Young Jae JANG, Ansan-si (KR); Young-Gi LEE, Daejeon (KR); Ju Young KIM, Daejeon (KR); Dong Ok SHIN, Daejeon (KR)

(73) Assignees: Electronics and Telecommunications Research Institute, Daejeon (KR); APEC, LTD., Ansan-si (KR)

(21) Appl. No.: 18/319,965

(22) Filed: May 18, 2023

(30) Foreign Application Priority Data
May 20, 2022 (KR) 10-2022-0062099
Aug. 25, 2022 (KR) 10-2022-0106914

(51) Int. Cl. H01M 50/42; H01M 50/449; H01M 50/446; H01M 50/403

(52) U.S. Cl. CPC H01M 50/42; H01M 50/449; H01M 50/446; H01M 50/403

(57) ABSTRACT

Provided is a method for manufacturing a binder for coating a secondary battery separator, wherein the method may include performing a first polymerization on a first monomer to form a precursor solution including a chain-type particle, and adding a second monomer to the precursor solution and performing a second polymerization to form an emulsion particle on the chain-type particle. In an embodiment, the second polymerization may include an emulsification polymerization in which the chain-type particle acts as an emulsifier.

### CROSS-REFERENCE TO RELATED APPLICATIONS

This U.S. non-provisional patent application claims priority under 35 U.S.C. § 119 of Korean Patent Application Nos. 10-2022-0062099, filed on May 20, 2022, and 10-2022-0106914, filed on Aug. 25, 2022, the entire contents of which are hereby incorporated by reference.

### BACKGROUND

The present disclosure herein relates to a method for manufacturing a binder for coating a secondary battery separator and a method for manufacturing a secondary battery separator.

A lithium-ion secondary battery is currently used as a core power source for a portable electronic communication device such as a mobile phone, a laptop, or the like. Compared to other energy storage devices such as a capacitor and a fuel cell, the lithium-ion secondary battery shows high storage capacity, excellent charging and discharging properties, high processability, etc., and thus is attracting great attention as a next-generation energy storage device for a wearable device, an electric vehicle, an energy storage system (ESS), or the like.

A lithium secondary battery is a battery composed of a positive electrode, a negative electrode, an electrolyte which provides a path for lithium ions to move between the positive electrode and the negative electrode, and a separator, and generates electrical energy by oxidation and reduction reactions when lithium ions are intercalated and de-intercalated in the positive electrode and the negative electrode. A lithium metal having a high lithium secondary battery energy density is used as a negative electrode, and a liquid solvent is used as an electrolyte. Currently, in a lithium secondary battery, an organic liquid electrolyte is used as a driving element of a high-performance and high-energy storage device.

However, since the lithium secondary battery uses a non-aqueous electrolyte solution having a high risk of ignition, and is operated in a high voltage range, an unexpected fire accident may occur. Particularly, as the trend in the secondary battery industry is shifting from using small secondary batteries as power sources for such as mobile phones and portable devices to using medium-and-large-sized secondary batteries as power sources for such as electric vehicles and energy storage systems, the above stability problem is becoming more prominent.

### SUMMARY

The present disclosure provides a method for manufacturing a binder for coating a secondary battery separator with improved thermal stability and mechanical stability.

The present disclosure also provides a method for manufacturing a secondary battery separator with improved thermal stability and mechanical stability.

The problems to be solved by the inventive concept are not limited to the above-mentioned problems, and other problems that are not mentioned may be apparent to those skilled in the art from the following description.

An embodiment of the inventive concept provides is a method for manufacturing a binder for coating a secondary battery separator, wherein the method includes performing a first polymerization on a first monomer to form a precursor solution including a chain-type particle, and adding a second monomer to the precursor solution and performing a second polymerization to form an emulsion particle on the chain-type particle. In an embodiment, the second polymerization may include an emulsification polymerization in which the chain-type particle acts as an emulsifier.

In an embodiment, the chain-type particle and the emulsion particle may be chemically bonded.

In an embodiment, the first polymerization may be a redox polymerization.

In an embodiment, in the second polymerization, the chain-type particle and the emulsion particle may form a particle of a core-shell structure, wherein the chain-type particle may constitute a shell, and the emulsion particle may constitute a core.

In an embodiment, the weight average molecular weight (Mw) of the chain-type particle may be about 5,000 to about 1,000,000.

In an embodiment, the first monomer may include at least one of acrylic acid, methacrylic acid, sodium acrylate, or sodium methacrylate or a combination thereof.

In an embodiment, the first polymerization may include further adding a comonomer to the first monomer, wherein the comonomer may include at least one of carboxyethyl acrylate, hydroxyethyl acrylate, ethylhexyl acrylate, methyl acrylate, ethyl acrylate, butyl acrylate, hexyl acrylate, lauryl acrylate, propargyl acrylate, isobutyl acrylate, methyl methacrylate, ethyl methacrylate, butyl methacrylate, hydroxyethyl methacrylate, hydroxypropyl methacrylate, ethylhexyl methacrylate, glycidyl methacrylate, stearyl methacrylate, lauryl methacrylate, acrylonitrile, acrylamide, or methacrylamide or a combination thereof.

In an embodiment, the first polymerization may include adding a first initiator to the first monomer, wherein the first initiator may include at least one of potassium persulfate, potassium bisulfite, sodium peroxomonosulfate, sodium peroxydiphosphate, or ammonium persulfate potassium sulfate, possium bisulfite, sodium peroxomonosulfate, sodium peroxydiphosphate, or ammonium persulfate or a combination thereof.

In an embodiment, the second monomer may include at least one of carboxyethyl acrylate, hydroxyethyl acrylate, ethylhexyl acrylate, methyl acrylate, ethyl acrylate, butyl acrylate, hexyl acrylate, lauryl acrylate, propargyl acrylate, isobutyl acrylate, methyl methacrylate, ethyl methacrylate, butyl methacrylate, hydroxyethyl methacrylate, hydroxypropyl methacrylate, ethylhexyl methacrylate, glycidyl methacrylate, stearyl methacrylate, lauryl methacrylate, acrylic acid, methacrylic acid, sodium acrylate, sodium methacrylate, acrylonitrile, acrylamide, or methacrylamide or a combination thereof.

In an embodiment, the second polymerization may include further adding a second initiator to the precursor solution, wherein the second initiator may include at least one of hydrogen peroxide, ammonium persulfate, ferrous salt, potassium sulfate, sodium bisulfite, sodium peroxomono sulfate, or sodium peroxydiphosphate or a combination thereof.

In an embodiment of the inventive concept, a method for manufacturing a secondary battery separator includes adding an acrylic acid-based monomer and a first initiator to a solvent and performing a first polymerization to form a precursor solution including chain-type particle, adding an acrylic monomer and a second initiator to the precursor solution and performing a second polymerization to prepare a binder, dispersing ceramic particles in the binder to prepare a slurry, and coating the slurry onto a separator substrate to form a coating film. In an embodiment, the second polymerization may include the formation of an emulsion particle on the chain-type particle, and the binder may include a particle of a core-shell structure in which the chain-type particle surrounds the emulsion particle.

In an embodiment, the first polymerization may include further adding a comonomer to the acrylic acid-based monomer, wherein, wherein the comonomer may include at least one of carboxyethyl acrylate, hydroxyethyl acrylate, ethylhexyl acrylate, methyl acrylate, ethyl acrylate, butyl acrylate, hexyl acrylate, lauryl acrylate, propargyl acrylate, isobutyl acrylate, methyl methacrylate, ethyl methacrylate, butyl methacrylate, hydroxyethyl methacrylate, hydroxypropyl methacrylate, ethylhexyl methacrylate, glycidyl methacrylate, stearyl methacrylate, lauryl methacrylate, acrylonitrile, acrylamide, or methacrylamide or a combination thereof.

In an embodiment, the weight average molecular weight (Mw) of the binder may be about 10,000 to about 1,500,000.

In an embodiment, the average particle size of the binder may be about 0.1 μm to about 5 μm.

In an embodiment, the chain-type particle and the emulsion particle may be chemically bonded.

In an embodiment, the first polymerization may be a redox polymerization.

In an embodiment, the second polymerization may include an emulsification polymerization in which the chain-type particle acts as an emulsifier.

In an embodiment, the ceramic particles may include at least one of alumina, boehmite, silicon dioxide, titanium dioxide, zirconium dioxide, ruthenium oxide, iron oxide, cobalt oxide, or nickel oxide or a combination thereof.

In an embodiment, the weight ratio of the ceramic particles to the binder may be about 80:20 to about 99:1.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 is a cross-sectional view of a secondary battery according to embodiments of the inventive concept;

FIG. 2 is a cross-sectional view of a binder for coating a secondary battery separator according to embodiments of the inventive concept;

FIG. 3 is a cross-sectional view of a ceramic slurry for coating a secondary battery separator according to embodiments of the inventive concept;

FIG. 4 is a flowchart showing a method for manufacturing a secondary battery separator according to embodiments of the inventive concept;

FIG. 5 is a graph showing results of measuring the liquid electrolyte uptake properties of a separator manufactured in each of Example 4 to Example 6, Comparative Example 1, and Comparative Example 2;

FIG. 6 is a graph showing results of measuring the ionic conductivity of the separator manufactured in each of Examples 4 to 6 and Comparative Example 1; and

FIG. 7 is a graph comparing initial discharge capacities when a single cell is formed using the separator manufactured in each of Example 4 to Example 6, Comparative Example 1, and Comparative Example 2.

### DETAILED DESCRIPTION

In order to facilitate sufficient understanding of the configuration and effects of the present invention, preferred embodiments of the present invention will be described with reference to the accompanying drawings. However, the present invention is not limited to the embodiments set forth below, and may be embodied in various forms and modified in many alternate forms. Rather, these embodiments are provided so that this disclosure will be thorough and complete, and will fully convey the scope of the present invention to those skilled in the art to which the present invention pertains. Those skilled in the art will understand that the concepts of the present invention may be performed in any suitable environment.

The terms used herein are for the purpose of describing embodiments and are not intended to be limiting of the present invention. In the present disclosure, singular forms include plural forms unless the context clearly indicates otherwise. As used herein, the terms ‘comprises’ and/or ‘comprising’ do not preclude the presence or addition of one or more other components, steps, operations, and/or elements in addition to the stated components, steps, operations, and/or elements.

In the present disclosure, when a film (or layer) is referred to as being on another film (or layer) or substrate, it means that the film may be directly formed on another film (or layer) or substrate, or that a third film (or layer) may be interposed therebetween.

Although the terms first, second, third, and the like are used in various embodiments of the present disclosure to describe various regions, films (or layers), and the like, these regions, films, and the like should not be limited by these terms. These terms are only used to distinguish any predetermined region or film (or layer) from another region or film (or layer). Thus, a film referred to as a first film in one embodiment may be referred to as a second film in another embodiment. Each embodiment described and exemplified herein also includes a complementary embodiment thereof. Like reference numerals refer to like elements throughout the specification.

In the present specification, each of the phrases such as “A or B,” “at least one of A and B,” “at least one of A or B,” “A, B or C,” “at least one of A, B and C,” and “at least one of A, B, or C” may include any one of items listed together in a corresponding phrase among the phrases, or all possible combinations thereof.

In addition, embodiments described in the present specification will be described with reference to cross-sectional views and/or plan views which are ideal illustrations of the inventive concept. In the drawings, the thickness of films and regions are exaggerated for an effective description of technical contents. Accordingly, the shape of an example may be modified by manufacturing techniques and/or tolerances. Thus, the embodiments of the inventive concept are not limited to specific forms shown, but are intended to include changes in the form generated by a manufacturing process. Thus, the regions illustrated in the drawings have properties, and the shapes of the regions illustrated in the drawings are intended to exemplify specific shapes of regions of a device and are not intended to limit the scope of the inventive concept. Thus, the regions illustrated in the drawings have properties, and the shapes of the regions illustrated in the drawings are intended to exemplify specific shapes of regions of a device and are not intended to limit the scope of the inventive concept.

Unless otherwise defined, terms used in the embodiments of the inventive concept may be interpreted as meanings commonly known to those skilled in the art.

Hereinafter, a binder for coating a secondary battery separator according to the inventive concept and a secondary battery separator including the binder will be described with reference to the drawings.

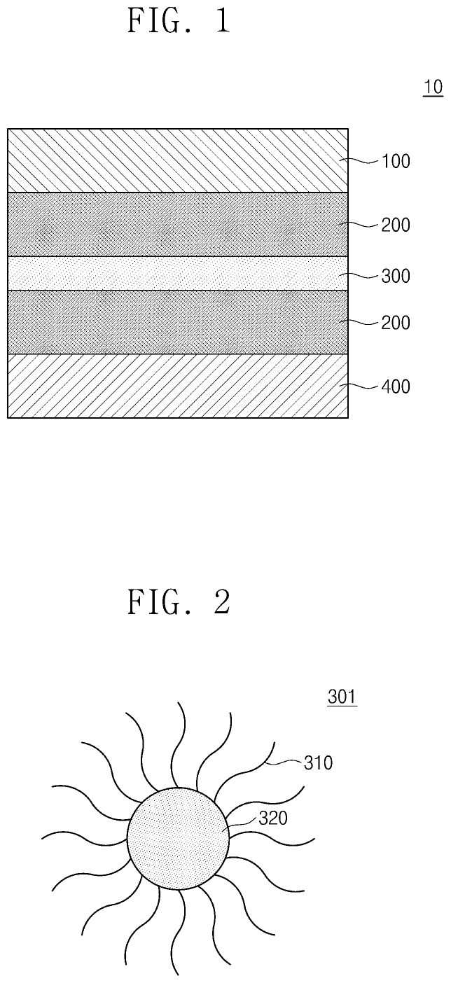

FIG. 1 is a cross-sectional view for describing a secondary battery according to embodiments of the inventive concept.

Referring to FIG. 1, a secondary battery 10 may include a positive electrode 100, an electrolyte 200, a separator 300, and a negative electrode 400. The positive electrode 100 and the negative electrode 400 may be disposed spaced apart with the separator 300 interposed therebetween. The positive electrode 100 and the negative electrode 400 may be disposed to oppose each other with the separator 300 interposed therebetween. The positive electrode 100, the negative electrode 400, and the separator 300 may be in contact with the electrolyte 200. For example, the electrolyte 200 may be provided between the positive electrode 100 and the separator 300 and between the negative electrode 400 and the separator 300.

The secondary battery 10 may be, for example, a lithium secondary battery. The positive electrode 100 may include a positive electrode active material. The positive electrode active material may include one of sulfur, LiCoO₂, LiNiO₂, LiNiₓCo_{y}Mn_{z}O₂ (x+y+z=1), LiMn₂O₄, or LiFeP₄, or a combination thereof. The negative electrode 400 may include a negative electrode active material. The negative electrode active material may include one of silicon (Si), tin (Sn), graphite, or lithium (Li), or a combination thereof. Each of the positive electrode 100 and the negative electrode 400 may include a polymer-type binder and a conductive material. The conductive material may serve to assist in the movement of electrons. The polymer-type binder may include one of an aqueous polymer (for example, carboxymethyl cellulose (CMC), polyacrylic acid (PAA)), polyvinylidene fluoride (PVdF), styrene-butadiene rubber (SBR), nitrile rubber (NBR), or polyvinylpyrrolidone (PVP), or a combination thereof. The conductive material may include at least one of carbon black, carbon nanotube (CNT), or graphene. The content ratio of the positive electrode active material, the polymer-type binder, and the conductive material may be about 80:10:10 to about 96:2:2. The content ratio of the negative electrode active material, the polymer-type binder, and the conductive material may be about 80:10:10 to about 96:2:2. However, the embodiment of the inventive concept is not limited thereto, and the content of the polymer-type binder or the conductive material may be adjusted according to the characteristics of the positive electrode active material or the negative electrode active material.

The electrolyte 200 is in contact with the positive electrode 100, the negative electrode 400, and the separator 300, and may serve to transfer ions to the positive electrode 100 and the negative electrode 400. For example, the ions may be lithium (Li) ions. The electrolyte 200 may include a liquid electrolyte. The electrolyte 200 may include a lithium salt and an organic solvent. The lithium salt may include one of LiPF₆, LiBF₄, LiSbF₆, LiAsF₆, LiClO₄, LiN(C₂F₅SO₂)₂, LiN(CF₃SO₂)₂, CF₃SO₃Li, LiC(CF₃SO₂)₃, or LiC₄BO₈, or a combination thereof. The organic solvent may include cyclic carbonate, or linear carbonate, or a combination thereof. As an example, the cyclic carbonate may include one of γ-butyrolactone, ethylene carbonate, propylene carbonate, glycerin carbonate, vinylene carbonate, or fluoroethylene carbonate, or a combination thereof. As an example, the linear carbonate may include one of dimethyl carbonate, diethyl carbonate, ethyl methyl carbonate, dimethoxyethane, or dimethyl ethylene carbonate, or a combination thereof. The concentration of the lithium salt in the electrolyte 200 may be about 1 M to about 3 M. The electrolyte 200 may further include an additive. The additive may include fluoroethylene carbonate or vinylene carbonate. The additive may improve the performance of a secondary battery according to embodiments of the inventive concept.

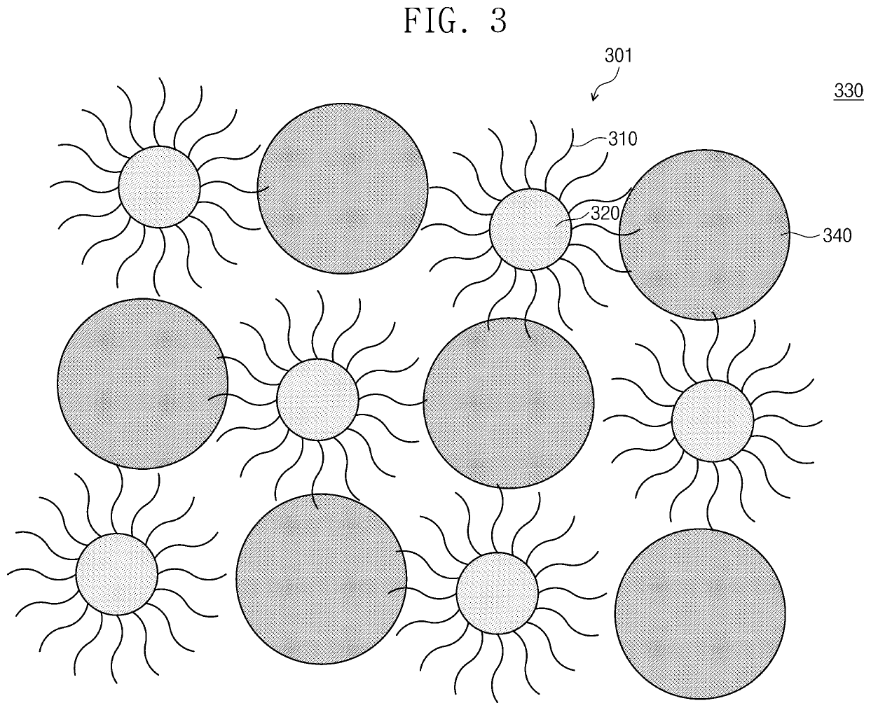

The separator 300 may be interposed between the positive electrode 100 and the negative electrode 400. The separator 300 may be disposed in the electrolyte 200. For example, a space between the positive electrode 100 and the separator 300 may be filled with the electrolyte 200, and a space between the negative electrode 400 and the separator 300 may be filled with the electrolyte 200. The separator 300 may include a separator substrate. The separator 300 may be prepared by coating a slurry 330 to be described later on a surface of the separator substrate. The separator substrate may include, for example, at least one of polyethylene, polyolefin such as polypropylene, and cellulose. The separator substrate may include, for example, a porous polymer film or a nonwoven fabric. Hereinafter, with reference to FIG. 2 and FIG. 3, the slurry 330 of the separator 300 will be described in more detail.

FIG. 2 is a cross-sectional view for describing a binder for coating a secondary battery separator according to embodiments of the inventive concept.

Referring to FIG. 2, a binder 301 may include a chain-type particle 310 and an emulsion particle 320. The binder 301 may further include a solvent.

As an example, the emulsion particle 320 may be, for example, a particle in a colloidal state dispersed in an emulsion. The emulsion particle 320 may have a sphere shape. However, the embodiment of the inventive concept is not limited thereto, and the emulsion particle 320 may have various shapes different from what is illustrated in FIG. 2. For example, the emulsion particle 320 may be a particle having an ellipsoidal shape, or may be a particle of an irregular shape. The emulsion particle 320 may include an acrylic polymer. For example, the emulsion particle 320 may include one of carboxyethyl acrylate, hydroxyethyl acrylate, ethylhexyl acrylate, methyl acrylate, ethyl acrylate, butyl acrylate, hexyl acrylate, lauryl acrylate, propargyl acrylate, isobutyl acrylate, methyl methacrylate, ethyl methacrylate, butyl methacrylate, hydroxyethyl methacrylate, hydroxypropyl methacrylate, ethylhexyl methacrylate, glycidyl methacrylate, stearyl methacrylate, lauryl methacrylate, acrylic acid, methacrylic acid, sodium acrylate, sodium methacrylate, acrylonitrile, acrylamide, or methacrylamide, or a combination thereof.

The chain-type particle 310 may be a polymer chain. The chain-type particle 310 may include an acrylic acid-based polymer. For example, the chain-type particle 310 may include one of acrylic acid, methacrylic acid, sodium acrylate, or sodium methacrylate, or a combination thereof. The chain-type particle 310 may further include a comonomer, wherein the comonomer may include one of carboxyethyl acrylate, hydroxyethyl acrylate, ethylhexyl acrylate, methyl acrylate, ethyl acrylate, butyl acrylate, hexyl acrylate, lauryl acrylate, propargyl acrylate, isobutyl acrylate, methyl methacrylate, ethyl methacrylate, butyl methacrylate, hydroxyethyl methacrylate, hydroxypropyl methacrylate, ethylhexyl methacrylate, glycidyl methacrylate, stearyl methacrylate, lauryl methacrylate, acrylonitrile, acrylamide, or methacrylamide, or a combination thereof. The weight-average molecular weight (Mw) of the chain-type particle 310 may be about 5,000 to about 1,000,000.

The binder 301 may be a combination of the chain-type particle 310 and the emulsion particle 320. The chain-type particle 310 may be disposed on a surface of the emulsion particle 320. The chain-type particle 310 may be radially cross-linked from the surface of the emulsion particle 320. The chain-type particle 310 may be connected on the surface of the emulsion particle 320. For example, one end of the chain-type particle 310 may be connected to the surface of the emulsion particle 320, and the chain-type particle 310 may extend in a direction away from the surface of the emulsion particle 320. The chain particle 310 may be provided in plurality. The chain-type particles 310 may surround a surface, i.e., the circumference surface, of the emulsion particle 320. As an example, the chain-type particles 310 and the emulsion particle 320 may form a core-shell structural particle. At this time, the chain-type particles 310 may correspond to a shell, and the emulsion particle 320 may correspond to a core. The chain-type particles 310 and the emulsion particle 320 may be chemically bonded. The emulsion particle 320 and the chain-type particles 310 may include different materials from each other.

The binder 301 may be an acrylic copolymer. The binder 301 may be an aqueous binder. The weight average molecular weight (Mw) of the binder 301 may be about 10,000 to about 1,500,000. The average particle size of the binder 301 may be about 0.1 μm to about 5 μm.

FIG. 3 shows a cross-sectional view of a ceramic slurry for coating a secondary battery separator according to an embodiment of the inventive concept.

Referring to FIG. 3, the slurry 330 may include the binder 301 and ceramic particles 340. The ceramic particles 340 may be dispersed in the slurry 330. The ceramic particles 340 may be cross-linked to each other by the binder 301. For example, the ceramic particles 340 may be connected to core-shell structural particles of the binder 301. The ceramic particles 340 may be connected to the chain-type particles 310 of the core-shell structural particles of the binder 301. However, the form in which the ceramic particles 340 are dispersed in the slurry 330 is not limited to what is illustrated, and the form in which the ceramic particles 340 are dispersed may vary according to the weight average molecular weight (Mw) of the binder 301. The composition ratio of the ceramic particles 340 to the binder 301 may be about 60:40 to about 99:1 based on the weight ratio, and may be, for example, about 80:20 to about 99:1.

The ceramic particles 340 may include one of alumina, boehmite, silicon dioxide, titanium dioxide, zirconium dioxide, ruthenium oxide, iron oxide, cobalt oxide, or nickel oxide, or a combination thereof. The particle size (D₅₀) of each of the ceramic particles 340 may be about 50 nm to about 5 μm. The particle size (D₅₀) of the ceramic particles 340 may affect the mobility of ions in the electrolyte 200. In the present specification, the above particle size (D₅₀) is a medium particle size, and represents the size of a particle when the particle size distribution is 50%, starting from particles with the smallest size.

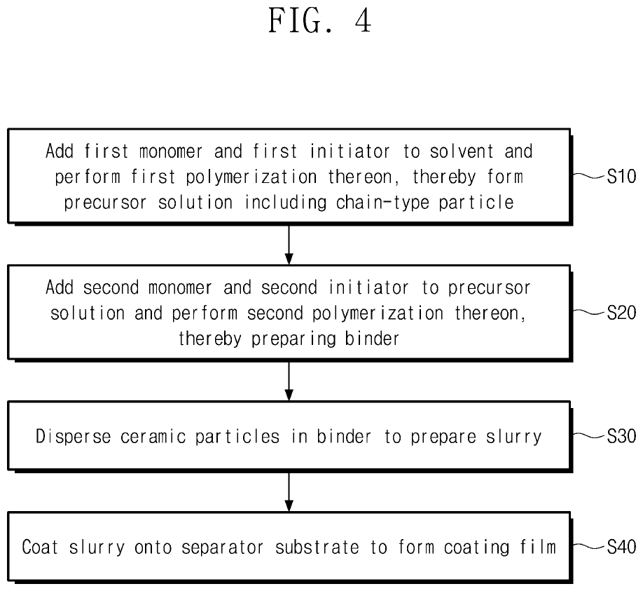

FIG. 4 is a flowchart showing a method for manufacturing a secondary battery separator according to an embodiment of the inventive concept. Hereinafter, the same contents as those described with reference to FIGS. 1 to 3 may be omitted.

Referring to FIG. 2 to FIG. 4, the method for manufacturing a secondary battery separator according to an embodiment of the inventive concept may include adding a first monomer and a first initiator to a solvent and performing a first polymerization to form a precursor solution including a chain-type particle S10, adding a second monomer and a second initiator to the precursor solution and performing a second polymerization to prepare a binder S20, dispersing ceramic particles in the binder to prepare a slurry S30, and coating the slurry onto a separator substrate to form a coating film S40.

The adding of a first monomer and a first initiator to a solvent and the performing of a first polymerization to form a precursor solution including a chain-type particle S10 may include initiating the first polymerization of the first monomer by the first initiator. The first polymerization may be a redox polymerization. The chain-type particle 310 may be formed by the first polymerization, and the chain-type particle 310 may include a polymer chain. The first polymerization may be performed in an elevated temperature state of about 60° C. to about 100° C. The solvent may be water. The first monomer may be an acrylic acid-based monomer. The first monomer may include one of acrylic acid, methacrylic acid, sodium acrylate, or sodium methacrylate, or a combination thereof. The first initiator may include one of potassium persulfate, potassium bisulfite, sodium peroxomonosulfate, sodium peroxydiphosphate, or ammonium persulfate potassium sulfate, possium bisulfite, sodium peroxomonosulfate, sodium peroxydiphosphate, or ammonium persulfate, may combination thereof. The first monomer may further include a comonomer. The comonomer may include one of carboxyethyl acrylate, hydroxyethyl acrylate, ethylhexyl acrylate, methyl acrylate, ethyl acrylate, butyl acrylate, hexyl acrylate, lauryl acrylate, propargyl acrylate, isobutyl acrylate, methyl methacrylate, ethyl methacrylate, butyl methacrylate, hydroxyethyl methacrylate, hydroxypropyl methacrylate, ethylhexyl methacrylate, glycidyl methacrylate, stearyl methacrylate, lauryl methacrylate, acrylonitrile, acrylamide, or methacrylamide, or a combination thereof.

The adding of a second monomer and a second initiator to the precursor solution and the performing of a second polymerization to prepare a binder S20 may include initiating the second polymerization of the chain-type particle 310 and the second monomer is initiated by the second initiator. The second polymerization may be an emulsification polymerization. In the second polymerization, the chain-type particles 310 may act as an emulsifier. The second polymerization may be to form the emulsion particle 320 on the chain-type particle 310. The second polymerization may be to chemically bond the chain-type particle 310 and the emulsion particle 320. Through the second polymerization, a particle of a core-shell structure in which the chain-type particle 310 surrounds the emulsion particle 320 may be formed. The binder 301 may include the particle of the core-shell structure. The particle of the core-shell structure may be a copolymer. The second polymerization may be performed in an elevated temperature state. The first polymerization and the second polymerization may be performed in the same reactor.

The second monomer may be an acrylic monomer. The second monomer may include one of carboxyethyl acrylate, hydroxyethyl acrylate, ethylhexyl acrylate, methyl acrylate, ethyl acrylate, butyl acrylate, hexyl acrylate, lauryl acrylate, propargyl acrylate, isobutyl acrylate, methyl methacrylate, ethyl methacrylate, butyl methacrylate, hydroxyethyl methacrylate, hydroxypropyl methacrylate, ethylhexyl methacrylate, glycidyl methacrylate, stearyl methacrylate, lauryl methacrylate, acrylic acid, methacrylic acid, sodium acrylate, sodium methacrylate, acrylonitrile, acrylamide, or methacrylamide, or a combination thereof.

The second initiator may include one of hydrogen peroxide, ammonium persulfate, ferrous salt, potassium sulfate, sodium bisulfite, sodium peroxomonosulfate, or sodium peroxydiphosphate, or a combination thereof.

The dispersing of ceramic particles in the binder to prepare a slurry S30 may accompany a stirring process to uniformly disperse the ceramic particles 340 in the binder 301. The ceramic particles 340 may be uniformly dispersed by the particle of the core-shell structure in the binder 301. For example, particles of the core-shell structure of the binder 301 may be connected to surfaces of the ceramic particles 340.

The coating of the slurry onto a separator substrate to form a coating film S40 may be performed by, for example, any one thickening process among a gravure coater method, a small-diameter gravure coater method, a reverse roll coater method, a transfer roll coater method, a kiss coater method, a dip coater method, a knife coater method, an air doctor blade coater method, a blade coater method, a bar coater method, a die coater method, a screen printing method, or a spray coater method. The forming of a coating film may further include a drying process. For example, the drying process may be performed by decompression drying after hot-air drying. However, the method for performing the drying process of the inventive concept is not limited as long as it is a method capable of completely removing moisture in the slurry. When a separator on which the coating film is form is applied to a secondary battery, the decompression drying may be performed for 1 hour or longer, in order to maintain a moisture content of a few ppm or less in an electrolyte of the secondary battery in contact with the separator. A temperature at which the decompression drying is performed may be about 100° C. or lower, and specifically, in order to prevent damage to the separator, the decompression drying may be performed at about 80° C. or lower.

The thickness of the coating film may be about 0.1 μm to about 10 μm. Preferably, the thickness may be about 0.5 μm to about 5 μm. When the thickness of the coating film is less than about 0.1 μm, the thermal stability of the separator on which the coating film is formed may be reduced. When the thickness of the coating film is greater than about 10 μm, the ion permeability of the separator may be reduced, and the weight and volume of the secondary battery may increase, which may reduce the energy density of the secondary battery. The coating film may have a porosity of about 20% to about 80%.

### Example 1

An acrylic acid monomer and water were added to a reactor, and then stirred at a speed of about 150 rpm. Thereafter, ammonium persulfate, an initiator, was added by 0.5 mol % of the content of the acrylic acid monomer, and a redox polymerization was performed at 70° C. to form an acrylic acid polymer chain.

Butyl acrylate, acrylonitrile, ethyl acrylate, and methacrylic acid monomer were added to the acrylic acid polymer chain at a weight ratio of 38:48:16:3, respectively, and then the mixture was stirred for 1 hour. Thereafter, ammonium persulfate, an initiator, was added to the reactor by 0.5 mol % of the content of the butyl acrylate, the acrylonitrile, the ethyl acrylate, and the methhacrylate monomer to perform emulsification polymerization at 60° C. for 3 hours, thereby synthesizing a core-shell aqueous binder. The weight average molecular weight (Mw) of the core-shell aqueous binder is about 1,000,000, and the average particle size thereof is about 1.8 μm.

### Example 2

A core-shell aqueous binder was synthesized in the same manner as in Example 1, except that the reaction temperature of the redox polymerization was set to 80° C. The weight average molecular weight (Mw) of the core-shell aqueous binder is about 800,000, and the average particle size thereof is about 1.4 μm.

### Example 3

A core-shell aqueous binder was synthesized in the same manner as in Example 1, except that the reaction temperature of the redox polymerization was set to 90° C. The weight average molecular weight (Mw) of the core-shell aqueous binder is about 750,000, and the average particle size thereof is about 1.3 μm.

### Example 4

Ceramic particles were dispersed in the core-shell aqueous binder synthesized in Example 1 to prepare a slurry. As the ceramic particles, alumina having a particle size (D₅₀) of about 279 nm was used. The polymer solid content in the core-shell aqueous binder was about 35 wt % to about 45 wt %, and water was further added to dilute the core-shell aqueous binder to a 5 wt % core-shell aqueous binder. Based on 10 g of a solute, 9.5 g of alumina and 10 g of an aqueous solution of the 5 wt % core-shell aqueous binder were mixed such that the weight ratio of the alumina to the core-shell aqueous binder was to be 95:5 so as to prepare a slurry. For uniform mixing, stirring was performed for 20 minutes at a speed of 2000 rpm using a planetary mixer, and the viscosity of the slurry was controlled to 300 cp to 400 cp. A process of coating the slurry was performed on a separator treated with ozone plasma through a doctor blade method. The height of the doctor blade was controlled at about 15 μm to finally coat the alumina/core-shell aqueous binder with a thickness of 5 μm on the separator.

### Example 5

A separator was coated in the same manner as in Example 4, except that the core-shell aqueous binder synthesized in Example 2 was used.

### Example 6

A separator was coated in the same manner as in Example 4, except that the core-shell aqueous binder synthesized in Example 3 was used.

### Comparative Example 1

In order to compare the performance and properties among Example 4 to Example 6, a slurry was not coated on a separator, and a separator treated with ozone plasma was used.

### Comparative Example 2

In order to compare the performance and properties among Example 4 to Example 6, ceramic particles were dispersed in an emulsion-type aqueous binder including only an emulsion particle so as to prepare a slurry. As the ceramic particles, alumina was used. The polymer solid content in the emulsion-type aqueous binder was 45 wt %, and water was further added to dilute the emulsion-type aqueous binder to a 5 wt % emulsion-type aqueous binder. Based on 10 g of a solute, 9.5 g of alumina and 10 g of the 5 wt % emulsion-type aqueous binder were mixed such that the weight ratio of the alumina to the emulsion-type aqueous binder was to be 95:5 so as to prepare a slurry. For uniform mixing, stirring was performed for 20 minutes at a speed of 2000 rpm using a planetary mixer, and the viscosity of slurry was controlled to 300 cp to 400 cp. A process of coating the slurry was performed on a separator treated with ozone plasma through a doctor blade method. The height of the doctor blade was controlled at about 15 μm to finally coat the alumina/emulsion-type aqueous binder with a thickness of 5 μm on the separator.

### EXPERIMENTAL EXAMPLES

The thickness and air permeability of the ceramic coated separator manufactured according to each of Example 4 to Example 6, Comparative Example 1, and Comparative Example 2 were measured and shown in [Table 1].

TABLE 1

| | Comparative | Comparative | | | |
|---|---|---|---|---|---|
| Classifications | Example 1 | Example 2 | Example 4 | Example 5 | Example 6 |
| Thickness (μm) | 11 | 16 | 16 | 16 | 16 |
| Air permeability | 168.2 | 229.0 | 178.9 | 181.2 | 190.7 |
| (sec/100 mL) | | | | | |

Referring to [Table 1], when the core-shell aqueous binder (Example 4 to Example 6) according to the inventive concept is applied to a separator, it can be confirmed that performance is remarkably improved in terms of air permeability compared to a separator (Comparative Example 1) to which ceramic coating is not applied and a separator (Comparative Example 2) to which an emulsion-type aqueous binder is applied.

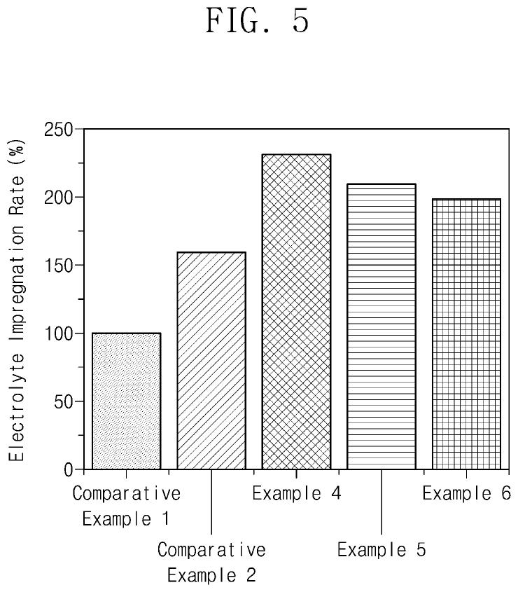

FIG. 5 is a graph showing results of measuring the liquid electrolyte uptake properties of the separator manufactured in each of Example 4 to Example 6, Comparative Example 1, and Comparative Example 2.

Referring to FIG. 5, it can be confirmed that Example 4 to Example 6 exhibit better electrolyte impregnation properties than Comparative Example 1 and Comparative Example 2. This means that in Example 4 to Example 6, electrolyte impregnation proceeds quickly and uniformly as the ceramic particles are coated on the surface of the separator in a uniform distribution.

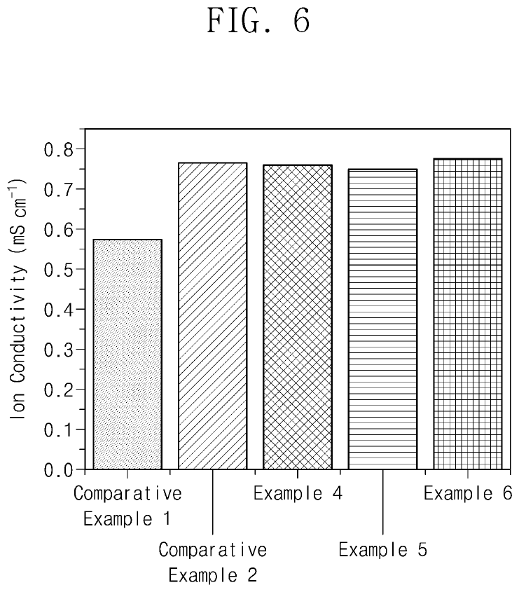

FIG. 6 is a graph showing results of measuring the ionic conductivity of the separator manufactured in each of Examples 4 to 6, and Comparative Example 1.

Referring to FIG. 6, it can be seen that the ionic conductivity of each of Example 4 to Example 6 which are coated with the ceramic particles is higher than that of Comparative Example 1. This may be due to the fact that the uniform distribution of the ceramic particles on the separator uniformly distributes the electrolyte, thereby improving ion mobility.

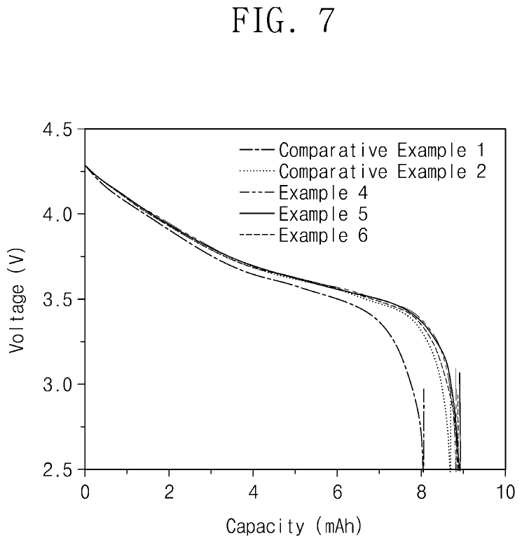

FIG. 7 is a graph comparing initial discharge capacities when a single cell is formed using the separator manufactured in each of Example 4 to Example 6, Comparative Example 1, and Comparative Example 2.

As a single cell for measuring charge and discharge performance, a mono cell in the form of a pouch having a dimension of 2 cm×2 cm was manufactured. At this time, the mono cell was manufactured by fixing the weight ratio of a natural graphite negative electrode active material:a SBR/CMC binder to 98:2 (SBR:CMC=1:1, weight ratio) for the composition of a negative electrode plate, and by fixing the weight ratio of a NCM622 positive electrode active material:a PVdF binder:a conductive material to 96:2:2 for the composition of a positive electrode plate. The thickness of an electrode was controlled and designed such that the ratio of positive electrode capacity/negative electrode capacity was to be 1.02. As an organic solvent, ethylene carbonate and ethylmethyl carbonate were mixed at a weight ratio of 3:7, and then a liquid electrolyte was prepared such that 1.3 M of lithium hexafluorophosphate lithium salt was to be dissolved. The liquid electrolyte was injected into the single cell to prepare a cell.

Referring to FIG. 7, the initial discharge capacity showed a different behavior from that of an impregnation amount and ion conductivity properties of the electrolyte. As described with reference to FIG. 5 and FIG. 6, Example 4 to Example 6 were improved in both impregnation amount and ion conductivity properties compared to Comparative Example 1. However, in the discharge capacity, it can be seen that Example 1 has a small capacity, whereas Example 4 to Example 6 coated with the ceramic particles exhibit similar discharge properties.

A binder for coating a secondary battery separator according to a manufacturing method of the present invention includes a particle of a core-shell structure, and thus may improve the dispersibility of ceramic particles, which may improve the air permeability of a secondary battery separator. In addition, the storage stability and long-term shelf life of the binder for coating a secondary battery separator may be improved. Therefore, the price competitiveness, thermal stability, and physical strength of a secondary battery separator according to the present invention may be improved.

In addition, a liquid electrolyte-based lithium secondary battery including the binder for coating a secondary battery separator according to the present invention may have improved thermal stability and mechanical stability, and the distribution of an electrolyte including lithium ions on the surface and inside of a secondary battery separator may be more uniformly controlled. Therefore, a lithium secondary battery with improved long-term lifespan properties and rate properties may be provided.

Although the present invention has been described with reference to the accompanying drawings, it will be understood by those having ordinary skill in the art to which the present invention pertains that various changes in form and details may be made therein without departing from the spirit and scope of the present invention. Therefore, it is to be understood that the above-described embodiments are exemplary and non-limiting in every respect.

What is claimed is:

1. A method for manufacturing a binder for coating a secondary battery separator, the method comprising:
performing a first polymerization on a first monomer to form a precursor solution including a chain-type particle; and
adding a second monomer to the precursor solution and performing a second polymerization to form an emulsion particle on the chain-type particle, wherein the second polymerization includes an emulsification polymerization in which the chain-type particle acts as an emulsifier.

2. The method of claim 1, wherein the chain-type particle and the emulsion particle are chemically bonded.

3. The method of claim 1, wherein the first polymerization is a redox polymerization.

4. The method of claim 1, wherein in the second polymerization, the chain-type particle and the emulsion particle form a particle of a core-shell structure, wherein the chain-type particle constitutes a shell, and the emulsion particle constitutes a core.

5. The method of claim 1, wherein the weight average molecular weight (Mw) of the chain-type particle is about 5,000 to about 1,000,000.

6. The method of claim 1, wherein the first monomer includes at least one of acrylic acid, methacrylic acid, sodium acrylate, or sodium methacrylate or a combination thereof.

7. The method of claim 1, wherein the first polymerization comprises further adding a comonomer to the first monomer, wherein the comonomer includes at least one of carboxyethyl acrylate, hydroxyethyl acrylate, ethylhexyl acrylate, methyl acrylate, ethyl acrylate, butyl acrylate, hexyl acrylate, lauryl acrylate, propargyl acrylate, isobutyl acrylate, methyl methacrylate, ethyl methacrylate, butyl methacrylate, hydroxyethyl methacrylate, hydroxypropyl methacrylate, ethylhexyl methacrylate, glycidyl methacrylate, stearyl methacrylate, lauryl methacrylate, acrylonitrile, acrylamide, or methacrylamide or a combination thereof.

8. The method of claim 1, wherein the first polymerization comprises adding a first initiator to the first monomer, wherein the first initiator includes at least one of potassium persulfate, potassium bisulfite, sodium peroxomonosulfate, sodium peroxydiphosphate, or ammonium persulfate potassium sulfate, possium bisulfite, sodium peroxomonosulfate, sodium peroxydiphosphate, or ammonium persulfate or a combination thereof.

9. The method of claim 1, wherein the second monomer includes at least one of carboxyethyl acrylate, hydroxyethyl acrylate, ethylhexyl acrylate, methyl acrylate, ethyl acrylate, butyl acrylate, hexyl acrylate, lauryl acrylate, propargyl acrylate, isobutyl acrylate, methyl methacrylate, ethyl methacrylate, butyl methacrylate, hydroxyethyl methacrylate, hydroxypropyl methacrylate, ethylhexyl methacrylate, glycidyl methacrylate, stearyl methacrylate, lauryl methacrylate, acrylic acid, methacrylic acid, sodium acrylate, sodium methacrylate, acrylonitrile, acrylamide, or methacrylamide or a combination thereof.

10. The method of claim 1, wherein the second polymerization comprises further adding a second initiator to the precursor solution, wherein the second initiator includes at least one of hydrogen peroxide, ammonium persulfate, ferrous salt, potassium sulfate, sodium bisulfite, sodium peroxomonosulfate, or sodium peroxydiphosphate or a combination thereof.

11. A method for manufacturing a separator for a secondary battery, the method comprising:
adding an acrylic acid-based monomer and a first initiator to a solvent and performing a first polymerization to form a precursor solution including a chain-type particle;
adding an acrylic monomer and a second initiator to the precursor solution and performing a second polymerization to prepare a binder;
dispersing a ceramic particle in the binder to prepare a slurry; and
coating the slurry onto a separator substrate to form a coating film,
wherein:
the second polymerization includes the formation of an emulsion particle on the chain-type particle; and
the binder includes a particle of a core-shell structure in which the chain-type particle surrounds the emulsion particle.

12. The method of claim 11, wherein the first polymerization comprises further adding a comonomer to the acrylic acid-based monomer, wherein the comonomer includes at least one of carboxyethyl acrylate, hydroxyethyl acrylate, ethylhexyl acrylate, methyl acrylate, ethyl acrylate, butyl acrylate, hexyl acrylate, lauryl acrylate, propargyl acrylate, isobutyl acrylate, methyl methacrylate, ethyl methacrylate, butyl methacrylate, hydroxyethyl methacrylate, hydroxypropyl methacrylate, ethylhexyl methacrylate, glycidyl methacrylate, stearyl methacrylate, lauryl methacrylate, acrylonitrile, acrylamide, or methacrylamide or a combination thereof.

13. The method of claim 11, wherein the weight average molecular weight (Mw) of the binder is about 10,000 to about 1,500,000.

14. The method of claim 11, wherein the average particle size of the binder is about 0.1 μm to about 5 μm.

15. The method of claim 11, wherein the chain-type particle and the emulsion particle are chemically bonded.

16. The method of claim 11, wherein the first polymerization is a redox polymerization.

17. The method of claim 11, wherein the second polymerization is an emulsification polymerization in which the chain-type particle acts as an emulsifier.

18. The method of claim 11, wherein the thickness of the coating film is about 0.1 μm to about 10 μm.

19. The method of claim 11, wherein the ceramic particles include at least one of alumina, boehmite, silicon dioxide, titanium dioxide, zirconium dioxide, ruthenium oxide, iron oxide, cobalt oxide, or nickel oxide or a combination thereof.

20. The method of claim 11, wherein the weight ratio of the ceramic particles to the binder is about 80:20 to about 99:1.
